(19) United States
(12) Patent Application Publication
(10) Pub. No.: US 2010/0193643 A1
(43) Pub. Date: Aug. 5, 2010

(54) LIFT FAN SYSTEM

(76) Inventors: Dmitriy B. Sidelkovskiy, Indianapolis, IN (US); Andrew Barlow, Indianapolis, IN (US)

Correspondence Address: KRIEG DEVAULT LLP, ONE INDIANA SQUARE, SUITE 2800, INDIANAPOLIS, IN, 46204-2079, US

(21) Appl. No.: 12/643,745

(22) Filed: Dec. 21, 2009

Related U.S. Application Data
(60) Provisional application No. 61/203,969, filed on Dec. 31, 2008.

(51) Int. Cl. B64C 29/00

(52) U.S. Cl. 244/23 B

(57) ABSTRACT

Embodiments of the present invention include a system, e.g., for a short takeoff and vertical landing (STOVL) aircraft. The system includes a power generator, such as a gas turbine engine; a lift fan powered by the power generator; and includes two or more nozzles in fluid communication with the lift fan.

### CROSS REFERENCE TO RELATED APPLICATIONS

The present application claims the benefit of U.S. Provisional Patent Application 61/203,969, filed Dec. 31, 2008, and is incorporated herein by reference.

### FIELD OF THE INVENTION

The present invention relates to aircraft propulsion, and, more particularly, to a system for a short takeoff and vertical landing aircraft.

### BACKGROUND

Short takeoff and vertical landing (STOVL) aircraft typically employ a system for providing a vertical thrust. The vertical thrust reduces or eliminates the need for forward aircraft motion during takeoff and landing operations.

### SUMMARY

Embodiments of the present invention include a system, e.g., for a short takeoff and vertical landing (STOVL) aircraft. The system includes a power generator, such as a gas turbine engine; a lift fan powered by the power generator; and includes two or more nozzles in fluid communication with the lift fan.

### BRIEF DESCRIPTION OF THE DRAWINGS

The description herein makes reference to the accompanying drawings wherein like reference numerals refer to like parts throughout the several views, and wherein:

FIG. 1 is a schematic view of a lift engine system in accordance with an embodiment of the present invention.

FIG. 2 is a cross-sectional depiction of a lift fan system having a main nozzle and an auxiliary thrust system in accordance with an embodiment of the present invention.

FIG. 3 depicts an embodiment of a lift fan system having a main nozzle and an auxiliary nozzle in accordance with another embodiment of the present invention.

FIGS. 4A and 4B depict an embodiment of the present invention wherein a lift fan system includes an auxiliary nozzle perimetrically disposed around a main nozzle.

FIG. 5 depicts an embodiment of the present invention wherein a lift fan system includes a main nozzle and two oppositely disposed auxiliary nozzles.

FIG. 6 depicts an embodiment of a lift fan system having a main nozzle and an auxiliary nozzle in accordance with yet another embodiment of the present invention.

### DETAILED DESCRIPTION

For purposes of promoting an understanding of the principles of the invention, reference will now be made to the embodiments illustrated in the drawings, and specific language will be used to describe the same. It will nonetheless be understood that no limitation of the scope of the invention is intended by the illustration and description of certain embodiments of the invention. In addition, any alterations and/or modifications of the illustrated and/or described embodiment(s) are contemplated as being within the scope of the present invention. Further, any other applications of the principles of the invention, as illustrated and/or described herein, as would normally occur to one skilled in the art to which the invention pertains, are contemplated as being within the scope of the present invention.

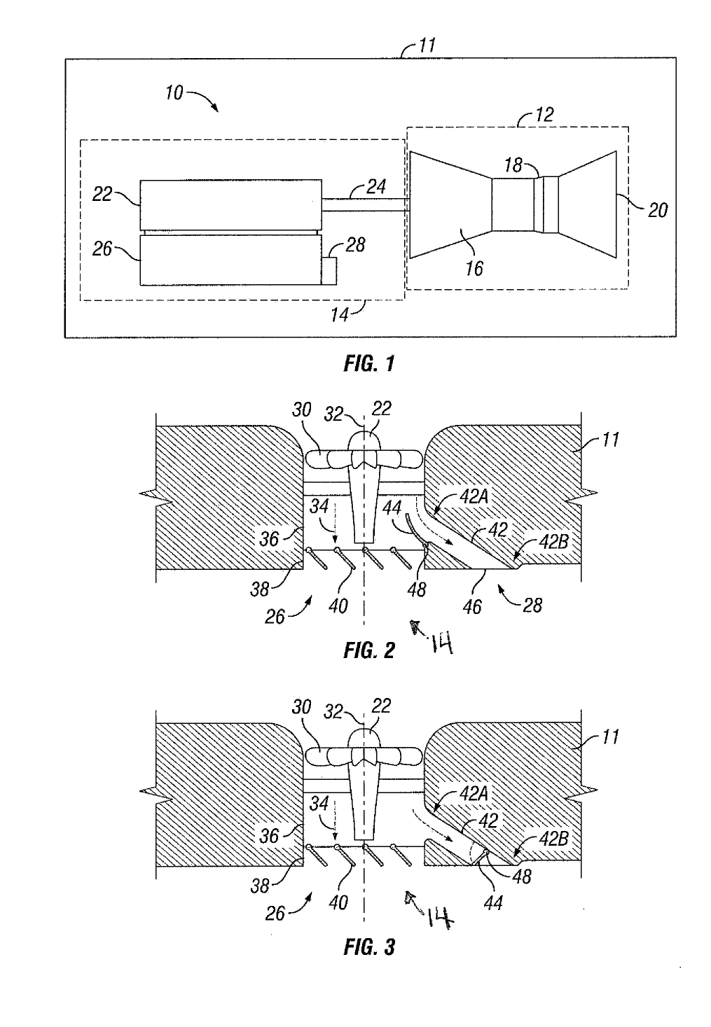

Referring now to FIG. 1, there is illustrated a generic representation of a lift engine system 10 for powering an aircraft 11, such as a short takeoff and vertical landing (STOVL) aircraft. In the embodiment of FIG. 1, various features, components and interrelationships therebetween of aspects of an embodiment of the present invention are depicted. However, the present invention is not limited to the particular embodiment of FIG. 1 and the components, features and interrelationships therebetween as are illustrated in FIG. 1 and described herein.

The non-limiting depiction of lift engine system 10 includes a power generator 12 and a lift fan system 14. In one form, power generator 12 is a gas turbine engine, referred to herein as gas turbine engine 12. In other embodiments, other power generator types may be employed, such as other types of heat engines and/or other systems that are capable of providing power, e.g., shaft power, pneumatic power, hydraulic power and/or electrical power,

Gas turbine engine 12 includes a compressor section 16, a combustor section 18 and a turbine section 20. In one form, lift fan system 14 includes a lift fan 22, a shaft system 24, a primary thrust output system in the form of a vanebox 26, and an auxiliary thrust output system 28. Lift fan 22 is coupled to gas turbine engine 12 via shaft system 24. In other embodiments, lift fan 22 may not include a shaft system such as shaft system 24, and may be coupled to the power generator by other suitable means, such as electrical, pneumatic and/or hydraulic lines.

Compressor section 16 compresses air received at the inlet of gas turbine engine 12, and may include one or more fan stages. Turbine section 20 is drivingly coupled to compressor section 16 via one or more shafts, and provides power to operate compressor section 16. Turbine section 20 may also be arranged to provide power for other components (not shown). Power is supplied from gas turbine engine 12 to lift fan 22 via shaft system 24. Lift fan 22 is adapted for mounting to aircraft 11, and discharges air to provide thrust, e.g., for STOVL aircraft 11, which is discharged through vanebox 26.

Referring to FIGS. 2 and 3, some non-limiting embodiments of lift fan system 14 are described. In the embodiments of FIGS. 2 and 3, lift fan system 14 is depicted as being installed in a wing portion of aircraft 11. However, it will be understood that in other embodiments, lift fan system 14 may be installed in other portions of fixed-wing and/or rotary-wing aircraft, e.g., in a fuselage and/or an empennage.

Various features, components and interrelationships therebetween of aspects of embodiments of the present invention are depicted in FIGS. 2 and 3. However, the present invention is not limited to the particular embodiments of FIGS. 2 and 3 and the components, features and interrelationships therebetween as are illustrated in FIGS. 2 and 3 and described herein.

In one form, lift fan 22 includes a plurality of blades 30 that rotate about an axis 32 to pressurize air received at the inlet of lift fan 22. In one form, axis 32 is substantially vertical in orientation. In other embodiments, axis 32 may be oriented in other directions. In one form, lift fan 22 is configured to discharge the pressurized air in downward direction 34 into vanebox 26 in order to provide thrust for vertical and/or short takeoff and landing of aircraft 11.

In one form, vanebox 26 includes a main duct 36 and a main nozzle 38. Main duct 36 is in fluid communication with lift fan 22. Nozzle 38 is in fluid communication with lift fan 22 via main duct 36. In one form, nozzle 38 is in the form of a plurality of pivotable vanes 40. In one form, vanes 40 are pivoted in a controlled manner by a mechanism (not shown) in order to control the amount of thrust output by lift fan 22, e.g., in response to control input from the pilot of aircraft 11, for example, via one or more flight control computers. In other embodiments, vanes 40 may be pivoted to control the direction of thrust output by vanebox 26 in addition to or in place of controlling the amount of thrust output by vanebox 26. Although nozzle 38 of the present embodiment is in the form of pivotable vanes 40, it will be understood that other embodiments of the present invention may employ other types of nozzles, e.g., including one or more vectoring or non-vectoring iris nozzles.

As the primary thrust output system for lift fan 22, vanebox 26 controllably discharges a portion of the pressurized air received from lift fan 22 to provide direct lift thrust, i.e., by controlling the amount and/or direction of thrust, as set forth above. Direct lift thrust is thrust having a substantial vertical component to lift aircraft 11 off the ground with little or no aircraft 11 forward velocity, as opposed to the indirect lift produced by the wings of aircraft 11 during forward flight.

In one form, auxiliary thrust output system 28 includes an auxiliary duct 42, a valve 44 and an auxiliary nozzle 46. Auxiliary thrust output system 28 is in fluid communication with lift fan 22. In one form, an end 42A of auxiliary duct 42 is fluidly coupled to main duct 36, and an end 42B of auxiliary duct 42 is fluidly coupled to auxiliary nozzle 46. Valve 44 is structured to regulate the airflow through auxiliary duct 42 and auxiliary nozzle 46, for example, by moving between a fully open position and a fully closed position.

In one form, valve 44 is in the form of a pivotable door that is rotatable about a pivot 48, e.g., in response to control input from the pilot of aircraft 11. In the embodiment of FIG. 2, valve 44 and pivot 48 are located at end 42A of auxiliary duct 42. In the embodiment of FIG. 3, valve 44 and pivot 48 are located at end 42B of auxiliary duct 42. In other embodiments, valve 44 and pivot 48 may be located elsewhere, including outside of auxiliary duct 42. In addition, other types of valves, with or without pivots, may be employed in other embodiments of the present invention.

During vertical/short takeoff and landing, auxiliary thrust output system 28 receives a portion of the pressurized air produced by lift fan 22 via main duct 36 to provide auxiliary thrust, which is a thrust output in addition to the main thrust output by nozzle 38 of the primary thrust output system (vanebox 26). The auxiliary thrust may include lift thrust, and may include vectoring thrust, that is, thrust used to control the orientation and/or position of aircraft 11.

Air pressurized by lift fan 22 is received into auxiliary duct 42 from main duct 36, and is controllably discharged through auxiliary nozzle 46 to generate the vectoring thrust. The amount of pressurized air received into auxiliary duct 42 is determined by valve 44, e.g., in response to control input from the pilot of aircraft 11, for example, via one or more flight control computers. In one form, the direction of the thrust output by auxiliary thrust output system 28 is determined by the orientation of auxiliary nozzle 46. In one form, the orientation of auxiliary nozzle 46 is changed via a mechanism (not shown), e.g., in response to control input from the pilot of aircraft 11, for example, via one or more flight control computers. In other embodiments, the orientation of auxiliary nozzle 46 may be fixed or manually adjustable. In still other embodiments, the thrust direction may be controlled by the use of turning vanes and/or additional ducting, in addition to or in place of orientation of nozzle 46 controlling the direction of thrust.

Although the present embodiment employs an auxiliary duct that receives the pressurized air from main duct 36, it will be understood that in other embodiments, auxiliary duct 42 may be in direct fluid communication with lift fan 22 in parallel with main duct 36, thus receiving pressurized air directly from lift fan 22 without the pressurized air having first passed through main duct 36.

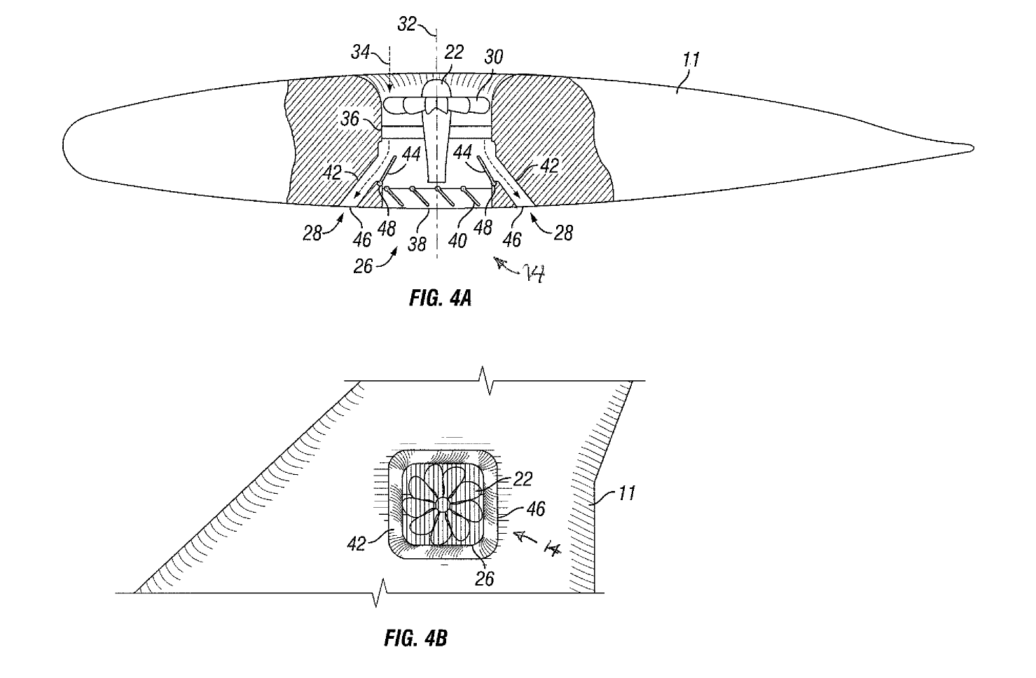

Referring to FIGS. 4A, 4B, 5 and 6, non-limiting examples of additional embodiments of lift fan system 14 are described. In the embodiments depicted in FIGS. 4A, 4B, 5 and 6, lift fan system 14 is installed in the wing portion of aircraft 11. In other embodiments, lift fan system 14 may be installed in other portions of fixed-wing and rotary-wing aircraft, e.g., in a fuselage and/or an empennage, in addition to or in place of the wing portion.

In any case, various features, components and interrelationships therebetween of aspects of embodiments of the present invention are depicted in of FIGS. 4A, 4B, 5 and 6. However, the present invention is not limited to the particular embodiments of FIGS. 4A, 4B, 5 and 6 and the components, features and interrelationships therebetween as are illustrated in FIGS. 4A, 4B, 5 and 6 and described herein.

In the embodiment of FIGS. 4A and 4B, auxiliary thrust output system 28 is perimetrically disposed around vanebox 26. For example, as illustrated in FIG. 4B, auxiliary nozzle 46 is perimetrically disposed around nozzle 38, i.e., extending around the perimeter of nozzle 38. In one form, auxiliary nozzle 46 extends around the entire perimeter of nozzle 38. In other embodiments, auxiliary nozzle 46 may extend only partially around the perimeter of nozzle 38. In still other embodiments, nozzle 46 may be subdivided into a plurality of individual nozzles disposed about the perimeter of nozzle 38. In one form, auxiliary duct 42 extends around the perimeter of main duct 36. In other embodiments, auxiliary duct 42 may extend only partially around the perimeter of nozzle 38. In still other embodiments, duct 42 may be subdivided into a plurality of individual ducts disposed about the perimeter of nozzle 38, A plurality of valves 44 with pivots 48 are employed in the embodiment of FIGS. 4A and 4B, e.g., one for each side of the generally square-shaped auxiliary duct 42 and auxiliary nozzle 46 depicted.

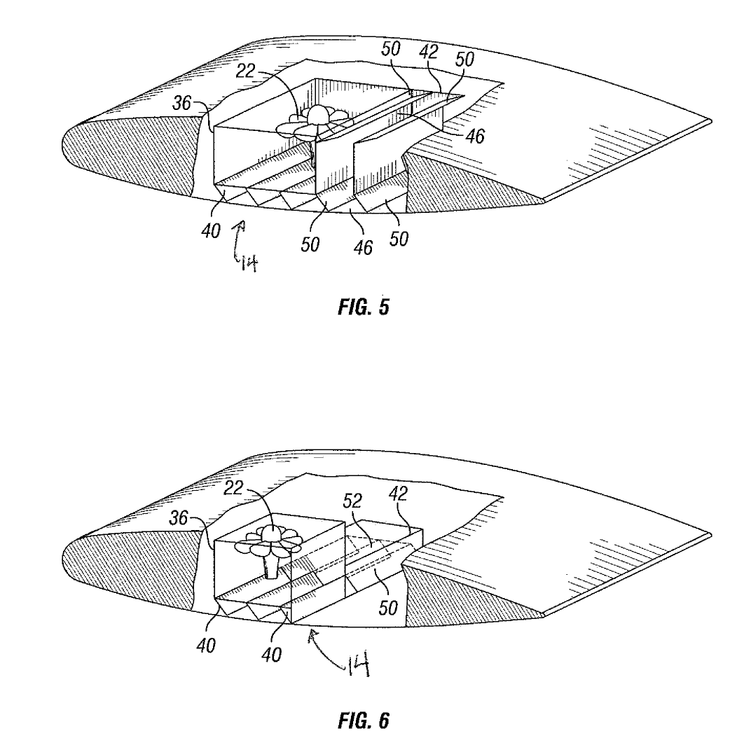

In the embodiment of FIG. 5, two opposed auxiliary nozzles 46 in the form of pivotable vanes 50 are employed. In one form, each auxiliary nozzle 46 is in fluid communication with lift fan 22 via main duct 36 and auxiliary duct 42, and receives a portion of the pressurized air produced by lift fan 22. Auxiliary duct 42 channels portions of the pressurized air to each auxiliary nozzle 46. The pressurized air is discharged by each auxiliary nozzle as auxiliary thrust.

In one form, vanes 50 are pivoted in a controlled manner by a mechanism (not shown) in order to control the amount of thrust output by auxiliary thrust output system 28, e.g., in response to control input from the pilot of aircraft 11, for example, via one or more flight control computers. In other embodiments, vanes 50 may be pivoted to control the direction of thrust output by auxiliary thrust output system 28 in addition to or in place of controlling the amount of thrust output by auxiliary thrust output system 28. Although auxiliary nozzle 46 of the present embodiment is in the form of pivotable vanes 50, it will be understood that other embodiments of the present invention may employ other types of nozzles, e.g., including one or more vectoring or non-vectoring iris nozzles.

In the embodiment of FIG. 6, auxiliary nozzle 46 includes a plurality of pivotable vanes 52 positioned adjacent to pivotable vanes 40 of vanebox 26. In one form, vanes 52 are in fluid communication with lift fan 22 via main duct 36 and auxiliary duct 42. Vanes 52 may be pivoted in a controlled manner by a mechanism (not shown) in order to control the amount and/or direction of thrust output by auxiliary thrust output system 28, e.g., in response to control input from the pilot of aircraft 11, for example, via one or more flight control computers. Although auxiliary nozzle 46 of the present embodiment is in the form of pivotable vanes 52, it will be understood that other embodiments of the present invention may employ other types of nozzles, e.g., including one or more vectoring or non-vectoring iris nozzles.

Embodiments of the present invention may include a system comprising a power generator; and a lift fan system. The lift fan system may include a lift fan coupled to and driven by the power generator, the lift fan being adapted for mounting to an aircraft and structured to pressurize air; a main nozzle in fluid communication with the lift fan and adapted to discharge a first portion of pressurized air from the lift fan to provide direct lift to the aircraft; and an auxiliary nozzle in fluid communication with the lift fan and adapted to discharge a second portion of the pressurized air from the lift fan to provide auxiliary thrust.

The lift fan system may include a valve structured to regulate the second portion of the pressurized air discharged from the auxiliary nozzle.

The system may include a main duct and an auxiliary duct, wherein, the main duct is fluidly disposed between the lift fan and the main nozzle, the main duct being structured to direct the first portion of the pressurized air to the main nozzle; and the auxiliary duct is fluidly disposed between the lift fan and the second nozzle, the auxiliary duct being structured to direct the second portion of the pressurized air to the auxiliary nozzle. The auxiliary duct may be in fluid communication with the lift fan via said main duct.

The system may include an other auxiliary nozzle in fluid communication with the lift fan and adapted to discharge a third portion of the pressurized air from the lift fan to provide additional auxiliary thrust. The lift fan system further including a main duct and an auxiliary duct, wherein the main duct is fluidly disposed between the lift fan and the main nozzle, the main duct being structured to direct the first portion of the pressurized air to the main nozzle; and the auxiliary duct is fluidly disposed between the lift fan, the auxiliary nozzle and the other auxiliary nozzle, wherein the auxiliary duct is structured to channel the second portion of the pressurized air to the auxiliary nozzle and to channel the third portion to the other auxiliary nozzle. The auxiliary duct may be fluidly disposed between the main duct, the auxiliary nozzle and the other auxiliary nozzle. The power generator may be a gas turbine engine.

Embodiments of the present invention also include a lift fan system. The lift fan system may include a lift fan adapted for installation onboard an aircraft and structured to pressurize air; a first nozzle in fluid communication with the lift fan, the first nozzle being a variable geometry nozzle structured to controllably discharge a first portion of pressurized air from the lift fan; and a second nozzle in fluid communication with the lift fan, the second nozzle being independent of the first nozzle and structured to controllably discharge a second portion of the pressurized air.

The lift fan system may include a valve structured to regulate the second portion of the pressurized air discharged from the second nozzle.

The lift fan system may include a first duct fluidly coupling the lift fan with the first nozzle and the second nozzle. The lift fan system may also include a second duct fluidly coupling the first duct with the second nozzle. The second duct may have a first end adjacent to the first duct and a second end opposite the first end and adjacent to the second nozzle, and the lift fan system may include a valve structured to regulate the second portion of the pressurized air discharged from the second nozzle, the valve being positioned adjacent the first end. The second duct may have a first end adjacent to the first duct and a second end opposite the first end and adjacent to the second nozzle, and the system may include a valve structured to regulate the second portion of the pressurized air discharged from the second nozzle, the valve being positioned adjacent the second end.

The second nozzle may be perimetrically disposed around the first nozzle.

The lift fan may have a substantially vertical axis of rotation.

Embodiments of the present invention may include a lift fan system, which may include a lift fan adapted for installation onboard an aircraft and structured to pressurize air; means for providing direct lift thrust using a first portion of pressurized air received from the lift fan; and means for providing auxiliary thrust using a second portion of the pressurized air.

The means for providing direct lift thrust may include means for discharging the first portion.

The means for providing auxiliary thrust may include means for discharging the second portion. The means for providing auxiliary thrust may include means for ducting the second portion from the lift fan to the means for discharging. The means for providing auxiliary thrust may include means for regulating the second portion.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary. Still further, it will be understood that the phrase, “in one form,” references a particular embodiment, and that the phrase “in one form,” indicates at least implicitly that embodiments other than the described “one form” are also contemplated as being within the scope of the present invention, i.e., that embodiments of the present invention may include other forms not expressly mentioned herein.

What is claimed is:

1. A system, comprising:
a power generator; and
a lift fan system, wherein said lift fan system includes:
a lift fan coupled to and driven by said power generator, wherein said lift fan is adapted for mounting to an aircraft and is structured to pressurize air;
a main nozzle in fluid communication with said lift fan and adapted to discharge a first portion of pressurized air from said lift fan to provide direct lift to said aircraft; and
an auxiliary nozzle in fluid communication with said lift fan and adapted to discharge a second portion of pressurized air from said lift fan to provide auxiliary thrust.

2. The system of claim 1, wherein said lift fan system further includes a valve structured to regulate said second portion of pressurized air discharged from said auxiliary nozzle.

3. The system of claim 1, wherein said lift fan system further includes a main duct and an auxiliary duct, and wherein:
said main duct is fluidly disposed between said lift fan and said main nozzle, said main duct being structured to direct said first portion of pressurized air to said main nozzle; and
said auxiliary duct is fluidly disposed between said lift fan and said second nozzle, said auxiliary duct being structured to direct said second portion of pressurized air to said auxiliary nozzle.

4. The system of claim 3, wherein said auxiliary duct is in fluid communication with said lift fan via said main duct.

5. The system of claim 1, wherein said lift fan system further includes an other auxiliary nozzle in fluid communication with said lift fan, and wherein said other auxiliary nozzle is adapted to discharge a third portion of pressurized air from said lift fan to provide additional auxiliary thrust.

6. The system of claim 5, wherein said lift fan system further includes a main duct and an auxiliary duct, and wherein:
said main duct is fluidly disposed between said lift fan and said main nozzle, and wherein said main duct is structured to direct said first portion of pressurized air to said main nozzle; and
said auxiliary duct is fluidly disposed between said lift fan, said auxiliary nozzle and said other auxiliary nozzle; wherein said auxiliary duct is structured to channel said second portion of pressurized air to said auxiliary nozzle; and wherein said auxiliary duct is structured to channel said third portion of pressurized air to said other auxiliary nozzle.

7. The system of claim 6, wherein said auxiliary duct is fluidly disposed between said main duct, said auxiliary nozzle and said other auxiliary nozzle.

8. The system of claim 1, wherein said power generator is a gas turbine engine.

9. A lift fan system, comprising:
a lift fan adapted for installation onboard an aircraft and structured to pressurize air;
a first nozzle in fluid communication with said lift fan, wherein said first nozzle is a variable geometry nozzle structured to controllably discharge a first portion of pressurized air from said lift fan; and
a second nozzle in fluid communication with said lift fan, wherein said second nozzle is independent of said first nozzle and structured to controllably discharge a second portion of pressurized air.

10. The lift fan system of claim 9, further comprising a valve structured to regulate said second portion of said pressurized air discharged from said second nozzle.

11. The lift fan system of claim, 9, further comprising a first duct fluidly coupling said lift fan with said first nozzle and said second nozzle.

12. The lift fan system of claim 11, further comprising a second duct fluidly coupling said first duct with said second nozzle.

13. The lift fan system of claim 12, wherein said second duct includes a first end and a second end; wherein said first end is adjacent to said first duct and said second end is opposite said first end and adjacent to said second nozzle, further comprising a valve structured to regulate said second portion of pressurized air discharged from said second nozzle, wherein said valve is positioned adjacent to said first end.

14. The lift fan system of claim 12, wherein said second duct includes a first end and a second end, said first end being adjacent to said first duct and said second end being opposite said first end and adjacent to said second nozzle, further comprising a valve structured to regulate said second portion of said pressurized air discharged from said second nozzle, said valve being positioned adjacent said second end.

15. The lift fan system of claim 9, wherein said second nozzle is perimetrically disposed around said first nozzle.

16. The lift fan system of claim 9, wherein said lift fan has a substantially vertical axis of rotation.

17. A lift fan system, comprising:
a lift fan adapted for installation onboard an aircraft and structured to pressurize air;
means for providing direct lift thrust using a first portion of pressurized air received from said lift fan; and
means for providing auxiliary thrust using a second portion of pressurized air.

18. The lift fan system of claim 17, wherein said means for providing direct lift thrust includes means for discharging said first portion of pressurized air.

19. The lift fan system of claim 17, wherein said means for providing auxiliary thrust includes means for discharging said second portion of pressurized air.

20. The lift fan system of claim 19, wherein said means for providing auxiliary thrust includes means for ducting said second portion of pressurized air from said lift fan to said means for discharging.

21. The lift fan system of claim 19, wherein said means for providing auxiliary thrust includes means for regulating said second portion of pressurized air.
